(19) United States
(12) Patent Application Publication
(10) Pub. No.: US 2025/0187516 A1
(43) Pub. Date: Jun. 12, 2025

(54) INJECTION-MOLDED THERMOPLASTIC DEVICE WITH MELTABLE BODY FASTENING DEVICE

(71) Applicant: Toyota Motor Engineering & Manufacturing North America, Inc., Plano, TX (US)

(72) Inventors: Logan R. Astrike, Maysville, KY (US); Erik R. Thomas, South Rockwood, MI (US); Kelly Stillson, Jenison, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/607,890

(22) Filed: Mar. 18, 2024

Related U.S. Application Data
(60) Provisional application No. 63/608,335, filed on Dec. 11, 2023.

(51) Int. Cl. B60N 3/02; B60J 5/04

(52) U.S. Cl. CPC B60N 3/026; B60J 5/0468

(57) ABSTRACT

Systems, methods, and other embodiments described herein relate to the coupling of a thermoplastic body, such as a vehicle door pull-cup, to a substrate surface, such as an interior panel of the vehicle door. In one embodiment, an injection-molded thermoplastic device includes a thermoplastic body attachable to a substrate surface and a fastening device attached to the thermoplastic body to affix the thermoplastic body to the substrate surface. The fastening device includes 1) a meltable body affixed to a bottom surface of the thermoplastic body and extending away from the thermoplastic body, 2) an inverted alignment depression on a distal surface of the meltable body, and 3) a backflow-preventing rib extending between lateral sides of the meltable body.

### CROSS-REFERENCE TO RELATED APPLICATIONS

This application claims benefit of U.S. Provisional Application No. 63/608,335, filed on, Dec. 11, 2023, which is herein incorporated by reference in its entirety.

### TECHNICAL FIELD

The subject matter described herein relates, in general, to injection-molded thermoplastic devices and, more particularly, to an injection-molded thermoplastic device that is less susceptible to separation from a substrate surface.

### BACKGROUND

Injection-molded thermoplastic components are found in a variety of applications. As an example, such components are found throughout a vehicle. For example, vehicles include hinged doors through which occupants enter and exit the vehicle. During travel, a latch mechanism keeps the door in a closed position. To enter the vehicle from the exterior, an occupant grasps an exterior handle and engages a mechanism that releases the latch mechanism and allows the occupant to swing the door open. After entering the vehicle, the occupant shuts the door via a pull-cup. A pull-cup may be an injection-molded thermoplastic component of a vehicle door used by the occupant to close the door from inside the vehicle. In general, the pull-cup includes a cavity on the interior handle of the door that a user may grasp when closing the door, opening the door, or otherwise moving the door.

### SUMMARY

In one embodiment, example systems and methods relate to a manner of improving the robustness and rigidity of the attachment of an injection-molded thermoplastic device, such as a pull-cup, to a substrate surface, such as a panel of a vehicle door. In one embodiment, an injection-molded thermoplastic device is disclosed. The injection-molded thermoplastic device includes a thermoplastic body attachable to a substrate surface and a fastening device attached to the thermoplastic body to affix the thermoplastic body to the substrate surface. The fastening device includes 1) a meltable body affixed to a surface of the thermoplastic body and extending away from the thermoplastic body, 2) an inverted alignment depression on a distal surface of the meltable body, and 3) a backflow-preventing rib extending between lateral sides of the meltable body.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle door with a pull-cup that incorporates the meltable body fastening device disclosed herein.

FIG. 2 illustrates one embodiment of the pull-cup that incorporates the meltable body fastening device disclosed herein.

FIG. 3 illustrates one embodiment of the pull-cup installed in an interior panel of a vehicle door.

FIGS. 4A and 4B depict cross-sectional views of the meltable body fastening device and joining tool for attaching the pull-cup to the interior panel of the vehicle door.

FIG. 5 depicts a button formed by melting the meltable body to attach the pull-cup to the interior panel of the vehicle door.

FIG. 6 illustrates one embodiment of a thermoplastic body that incorporates the meltable body fastening device disclosed herein.

### DETAILED DESCRIPTION

As described above, many devices, such as vehicles, include injection-molded thermoplastic components. One particular example is a pull-cup that is installed on a vehicle door. An injection-molded thermoplastic device that exhibits an enhanced joint with a substrate surface is disclosed herein.

The thermoplastic device may take a variety of forms. As previously described, vehicle doors include a pull-cup on an interior panel of the door, which pull-cup may be an injection-molded thermoplastic device. The pull-cup allows an occupant to close the vehicle door and open the vehicle door from the inside of the vehicle. In general, the pull-cup includes a cavity on the interior portion of the door that a user may grasp when closing and opening the vehicle door. In an example, the pull-cup is a separate component from the interior panel and is affixed to the interior panel during manufacturing and assembly. In some examples, a pull-cup is snap-fit into the interior panel. For example, the pull-cup may include an angled head that deflects when inserted into an opening of an interior panel of the vehicle door. As the angled head passes through the opening, the lip of the head rebounds and presses against the surface of the interior panel. The interference between the interior panel and the lip of the pull-cup snap fit prevents the pull-cup from separating from the interior panel of the vehicle door.

While this snap-fit connection is intended to prevent pull-cup/panel separation, the nature of the pull-cup may render a snap-fit connection ineffective for its intended use. That is, the snap-fit arrangement may not be able to retain the pull cup during operation. For example, as a user grasps and squeezes the pull-cup to shut the vehicle door, the lip of the snap-fit head may slide along and off the interference surface of the panel opening. That is, as the pull-cup is squeezed, the extra space of the hole may allow the snap feature (e.g., the angled head) to pop out of the snap-fit receiving hole in the panel, thus separating the pull-cup and the interior panel. This separation may be undesirable aesthetically, result in an audible noise (e.g., a “pop”), and impede the desired operation and use of the pull-cup.

Thus, the injection-molded thermoplastic device of the present specification includes a mounting component that more securely and robustly retains the thermoplastic body to the substrate surface. Specifically, the injection-molded thermoplastic device of the present specification includes a heat stake or ultrasonic weld connection between the thermoplastic body and the substrate surface. The fastening device of the injection-molded thermoplastic device includes various structural features that improve the retention of the thermoplastic body to the substrate surface and that otherwise enhance the operation of the thermoplastic body.

Specifically, the fastening device includes a meltable body that extends away from the surface of the thermoplastic body. The meltable body has a cross-sectional area that fits within a corresponding receiving hole in the substrate surface, which receiving hole may have the same size and shape as a snap-fit head described above. When acted upon by a joining tool such as an ultrasonic welding horn or a heating tip, the meltable body plastically deforms against the opposing surface of the substrate surface through which the meltable body is passed. That is, an ultrasonic welding tool or heat staking tool melts the meltable body and pushes a molten or semi-molten volume of the meltable body against the opposing surface of the substrate surface. As such, the substrate surface is sandwiched between the thermoplastic body and a button formed by the deformed meltable body. In this fashion, the thermoplastic body is affixed to the substrate surface.

The fastening device includes an inverted alignment depression at a distal end of the extending meltable body. The heat staking tool or the ultrasonic welding horn, which deforms the meltable body, may include a tip that heats up or vibrates to generate heat. The tip is pressed against the meltable body to deform the body. The inverted alignment depression on the distal end of the meltable body ensures proper alignment of the tip with the meltable body to ensure a robust, strong, and structurally sound body-retaining button is formed. That is, if the tip is not aligned correctly with the meltable body, a weakened button or other physical deformity may result, which may compromise the holding force of the fastening device and may result in a poor appearance for an end user.

In addition to the inverted alignment depression, chamfers at the distal corners of the meltable body center the joining tool. That is, as depicted below, the interior of the joining tool may be concave. The concavity defines the shape of the button that is formed from the molten or semi-molten plastic portion of the meltable body. The curvature of the chamfers may align with the curvature of the joining tool to further ensure that the joining tool is aligned with the surface of the meltable body. Without the inverted alignment depression and the chamfers on the periphery of the meltable body, the joining tool may imprecisely align with the meltable body, or the joining tool may move during joining. Either case may result in a defective product and/or an undesired aesthetic effect.

The meltable body also includes a center rib that is perpendicular to and extends between the side surfaces of the meltable body. The center rib is formed on the top surface of the meltable body between the thermoplastic body and the meltable body. During joining, the meltable body becomes molten or semi-molten and forms a button on the opposite side of the substrate surface. During this process, molten or semi-molten portions of the meltable body may flow toward the thermoplastic body. In the specific case of a thermoplastic pull-cup, this molten resin may cool as a mass within the pull-cup or adjacent to the pull-cup body if allowed to flow, which may affect the structural integrity and/or aesthetic of the pull-cup. As such, the center rib acts as a wall or barrier that prevents the molten plastic from reaching the body of the pull-cup. In other words, the center rib prevents molten resin from flowing back through the substrate opening and up through the thermoplastic body/substrate surface mating gap. Molten plastic flowing through the opening may lead to an undesirable aesthetic during joining (e.g., ultrasonic welding or heat staking) and may affect the structural strength of the junction of the thermoplastic body/substrate surface.

Thus, the fastening device of the present specification includes a meltable body that is used to datum (or not) the thermoplastic body relative to the substrate surface. The fastening device includes locating elements (i.e., inverted alignment depression and chamfered edges) to create a more robust and repeatable melted button for providing reliable performance to meet targets.

Accordingly, the present specification describes a thermoplastic body mounting system that more securely and robustly retains the thermoplastic body (such as a vehicle pull-cup) in a receiving opening (such as a vehicle door interior panel). As such, a pull-cup of the present specification retains the pull-cup against the interior panel when subject to forces experienced when an occupant pulls, grasps, or squeezes the pull-cup to open or close a vehicle door from inside the vehicle. Moreover, the present fastening device does not compromise the structural functionality or strength of the pull-cup.

While particular reference is made to a pull-cup thermoplastic body and a vehicle interior panel substrate, the thermoplastic body may be of various types and joined to various substrate surfaces.

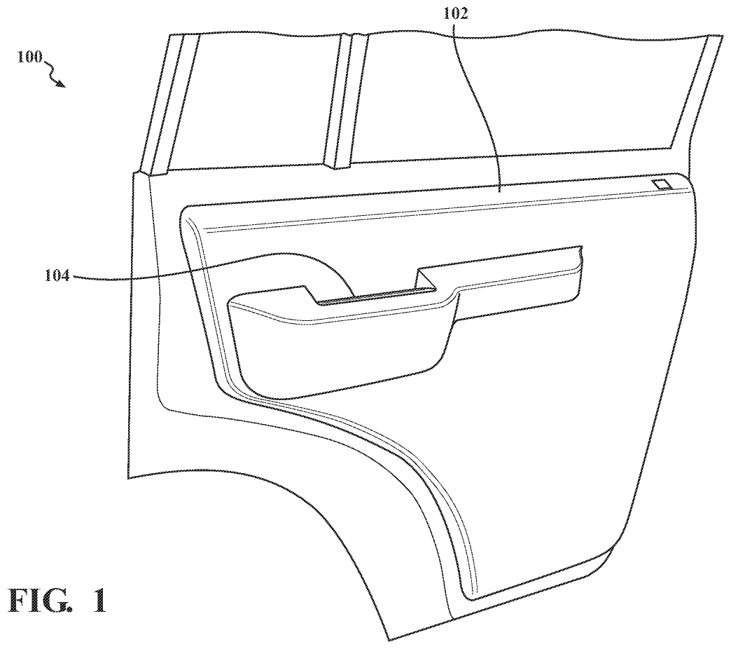

FIG. 1 illustrates one embodiment of a vehicle door 100, which is an example of a thermoplastic body, with a pull-cup 104, which is an example of a substrate surface that incorporates the meltable body fastening device disclosed herein. As used herein, a “vehicle” is any form of transport that may be motorized or otherwise powered. In one or more implementations, the vehicle is an automobile. While arrangements will be described herein with respect to automobiles, it will be understood that embodiments are not limited to automobiles. In some implementations, the vehicle may be another form of transport (e.g., boat or airplane) that, for example, includes a pull-cup 104 to close the vehicle door 100, and thus benefits from the functionality discussed herein associated with pull-cup retention to an interior panel of the vehicle door 100.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

Returning to FIG. 1, FIG. 1 depicts a vehicle door 100 which, as described above, allows the ingress and egress of an occupant from a vehicle. The vehicle door 100 may include a door trim assembly 102 that is found on an interior portion of the vehicle door 100 (i.e., facing the cabin of the vehicle) and which houses various components. For example, the door trim assembly 102 may include a lining that provides aesthetic qualities and hides various internal components (e.g., circuitry) of the vehicle door 100. As a particular example, a door may include mechanisms that unlock/lock the vehicle door 100, unlatch a latch mechanism of the vehicle door 100 to facilitate opening, and roll up and down windows of the vehicle door 100. These components and their associated circuitry, along with other components, may be concealed behind the lining of the door trim assembly 102.

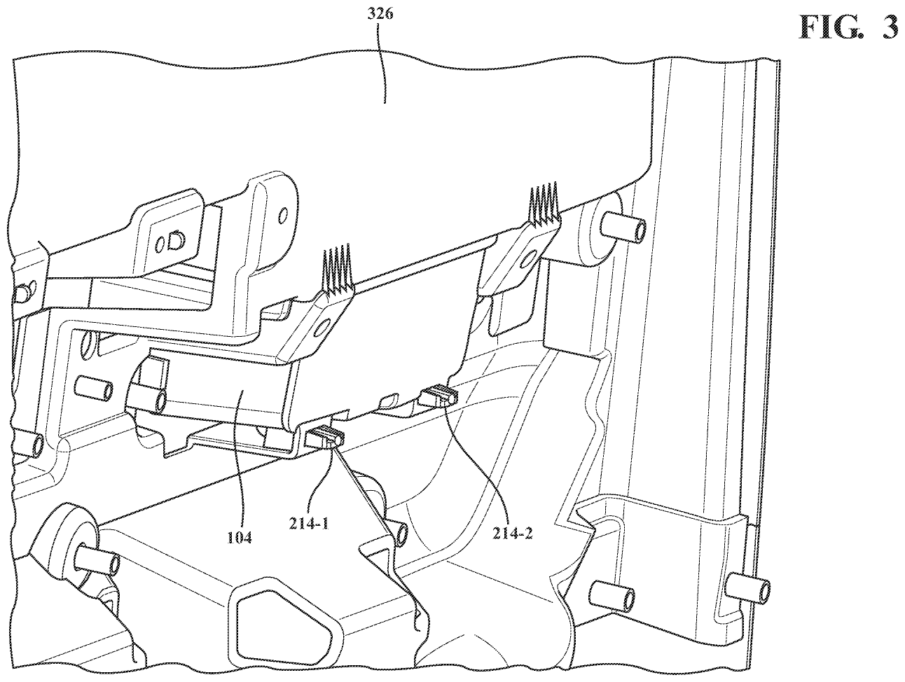

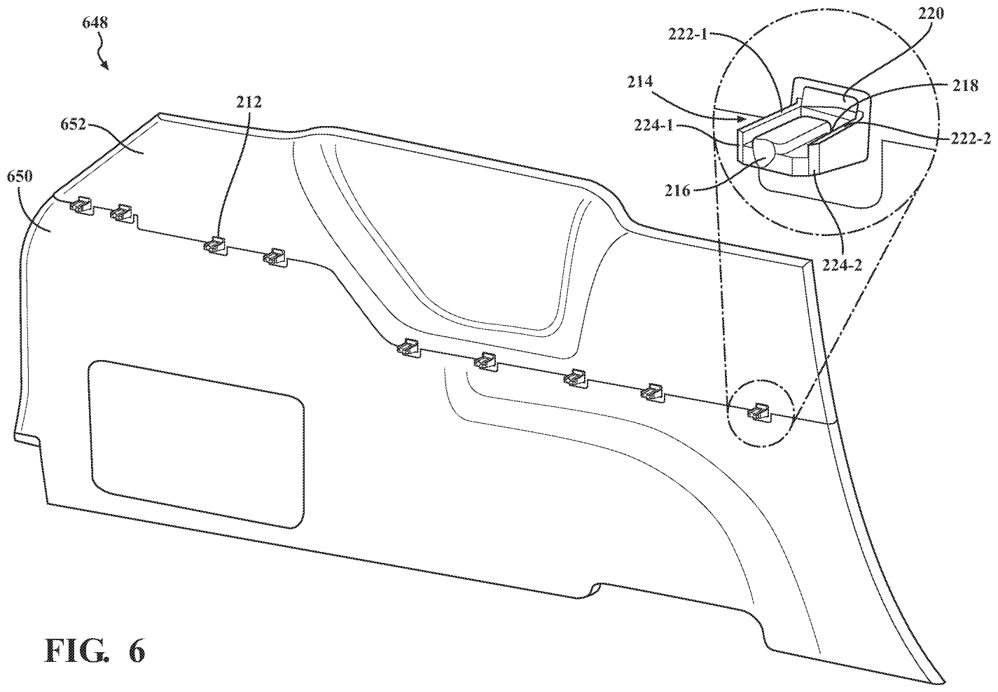

As depicted in FIG. 3 below, the door trim assembly 102 may include an interior panel to which various components of the vehicle door 100 are coupled. For example, a door handle, which unlatches the vehicle door 100 such that it may be opened and closed, may be affixed to the interior panel. Of particular relevance, the pull-cup 104, as described above, may be affixed to the interior panel such that an occupant may pull the vehicle door 100 closed or push the vehicle door 100 open. That is, the interior panel provides a rigid substrate to which door-manipulating components (e.g., door handle and pull-cup 104) are mounted to facilitate a sturdy, safe, and reliable manipulation of the vehicle door 100. As described above, the pull-cup 104 generally includes a cavity that an occupant grasps to open or close the vehicle door 100. The pull-cup 104 may be made of various materials, such as plastic, and may be separate from the interior panel but joined to such via the fastening device described below. Note that while FIGS. 1-5 depict the melting body fastening device joining a vehicle pull-cup 104 to an interior panel of a vehicle door 100; the injection-molded thermoplastic device may take various forms, another example of which is depicted below in connection with FIG. 6.

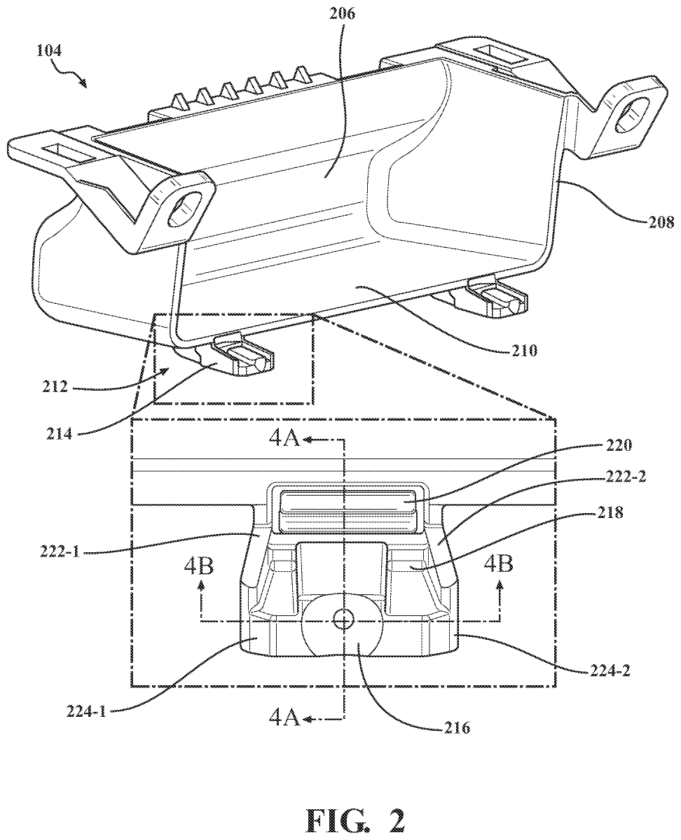

FIG. 2 illustrates one embodiment of the pull-cup 104 that incorporates the meltable body fastening device 212 disclosed herein. Specifically, FIG. 2 depicts the pull-cup device, which includes the pull-cup 104 and the fastening device 212. That is, as depicted in FIG. 2, the injection-molded thermoplastic body may be a pull-cup 104, and the substrate surface to which it is mounted may be an interior panel of a vehicle door 100.

In general, the pull-cup 104 includes a main body with various surfaces. Specifically, the pull-cup 104 includes a pull surface 206, which represents the portion of the pull-cup 104 grasped and pulled by the occupant to close the vehicle door 100. In general, the pull surface 206 of the pull-cup 104 may be disposed opposite an attachment surface 208 of the pull-cup 104. That is, the attachment surface 208 of the pull-cup 104 may be the surface adjacent to the interior panel of the vehicle door 100. The pull surface 206 of the pull-cup 104 is disposed towards the inside of the vehicle relative to the attachment surface 208. As depicted in FIG. 2, the pull surface 206 may be ergonomically shaped to conform to the contours of an occupant's hand to facilitate comfortable use of the pull-cup 104 to close the vehicle door 100.

The pull-cup 104 may include a surface such as a bottom surface 210. It is from this bottom surface 210 that features that affix the pull-cup 104 to the vehicle door 100 are found. Specifically, the door trim assembly 102 includes a fastening device 212 attached to the pull-cup 104 to affix the pull-cup 104 to the interior panel. Note that for simplicity, a single instance of a fastening device 212 is depicted with a reference number. However, multiple fastening devices 212 may be affixed to the pull-cup 104 bottom surface 210. The pull-cup 104 may be formed of various materials, including various plastics, which provide a rigid and sturdy surface that the occupant may pull or push against to open and close the vehicle door 100.

Returning to the fastening device 212, the fastening device 212 includes various features that robustly, securely, accurately, and reliably attach the pull-cup 104 to the interior panel. Each will be discussed in turn.

The fastening device 212 includes a meltable body 214 affixed to the bottom surface 210 of the pull-cup 104. The meltable body 214 extends away from the pull-cup 104. Specifically, in one example, the meltable body 214 extends away from the pull-cup 104 in a direction opposite the direction of the pull surface 206 of the pull-cup 104.

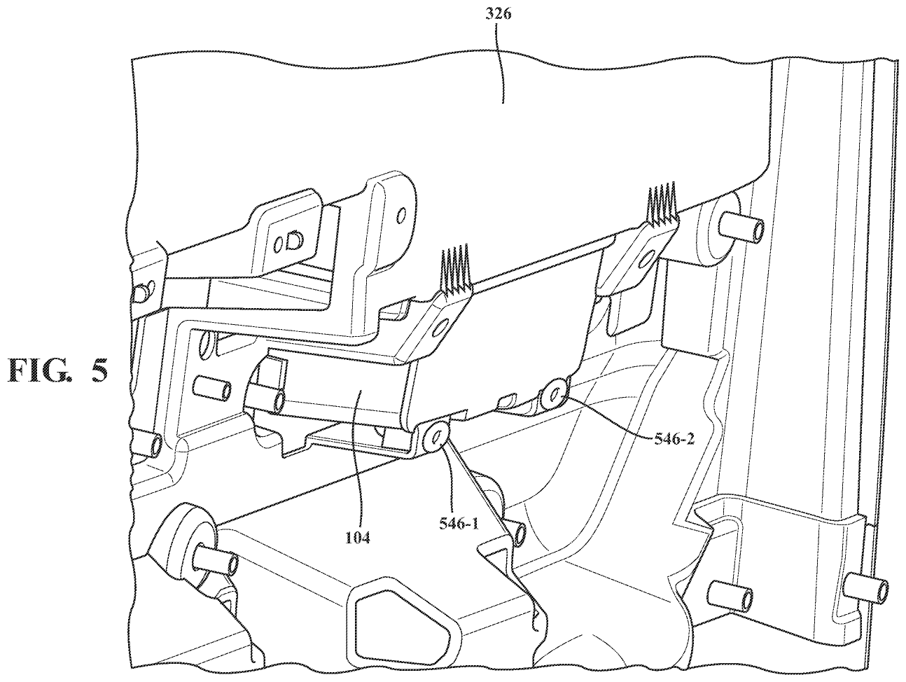

As described above, the meltable body 214 extends through an opening in the interior panel. The portion of the meltable body 214 that extends through the interior panel is acted upon by a joining tool such as a weld horn or a heat stake, which melts or partially melts the extending portion of the meltable body 214. Specifically, in heat staking, a heated tip is pressed into contact with a thermoplastic part. The heat from the tip softens the plastic material and forms a shape that is defined by the contours of the tip. An ultrasonic welder uses acoustic vibrations to generate frictional heat, softening the plastic material. As with heat staking, the ultrasonic welding horn forms the plastic material into a shape that is defined by the contours of the welding horn tip. In either case, the joining tool forms a button on the opposite surface of the interior panel, as depicted in FIG. 5 below. In this fashion, the interior panel is sandwiched between the pull-cup 104, specifically the attachment surface 208 of the pull-cup 104, and the button retaining the pull-cup 104 in place against the interior panel.

In one example, the fastening device 212 and its components are integrated with the pull-cup 104. That is, the pull-cup 104 and the fastening device 212 may form a single integrated body, for example, formed during an injection molded manufacturing operation.

In an example, the meltable body 214 may have a rectangular cross-section which, as depicted in FIG. 3 below, is sized to pass through a receiving hole in the interior panel. In one particular example, the receiving hole may have dimensions on the order of 5 millimeters by 13 millimeters, and the rectangular meltable body 214 may have dimensions smaller than that in either direction on the order of 0.1 to 0.2 millimeters to facilitate passage of the rectangular meltable body 214 through the receiving opening. That is, the cross-sectional dimensions of the rectangular meltable body 214 are smaller than those of the rectangular hole so that the meltable body 214 may slide into the rectangular hole. While particular reference is made to particular dimensions, shapes, and sizes of the meltable body 214 and associated receiving hole, the meltable body 214 and associated receiving hole may have a variety of dimensions, shapes, and sizes.

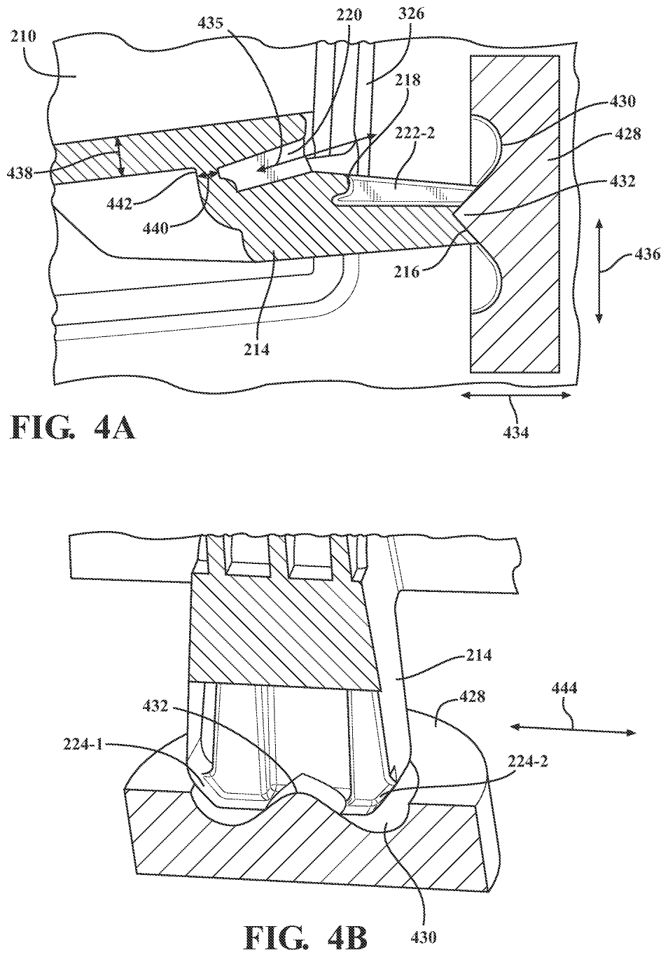

The fastening device 212 includes an inverted alignment depression 216 formed on a distal surface of the meltable body 214 (i.e., the surface of the meltable body 214 farthest from the pull-cup 104 body). During heat staking or ultrasonic welding, a joining tool tip is pressed against the meltable body 214. When manually operated, it may be difficult to properly align the joining tool tip with the meltable body 214. Even when operated robotically, there may be movement of the joining tool tip in various directions, which may result in an inaccurate or imprecise alignment of the joining tool tip with the meltable body 214. As described above, improper alignment of the joining tool tip with the meltable body 214 may result in a deformed button, or any other of a variety of aesthetic or structural deformations, which deformations may weaken the strength of the coupling. Accordingly, the inverted alignment depression 216 is a centering guide for the joining tool tip. Additional details regarding the inverted alignment depression 216 and its alignment with the joining tool tip are provided below in connection with FIGS. 4A and 4B.

The fastening device 212 includes a backflow-preventing rib 218 that extends perpendicularly between the lateral sides of the meltable body 214. The backflow-preventing rib 218 is formed on the top surface of the meltable body 214 between the pull-cup 104 and the meltable body 214. As the meltable body 214 becomes molten or semi-molten, molten plastic may flow toward the pull-cup 104. As described above, molten resin from the meltable body 214 may negatively impact the aesthetic and structural characteristics of the pull-cup 104. For example, if allowed to reach the bottom surface 210 of the pull-cup 104, the molten resin may warp the bottom surface 210. Moreover, the molten resin may seep between the interior panel and the pull-cup 104, providing an undesired aesthetic and potentially leaking onto or otherwise negatively impacting other components between the exterior door panel and the interior panel. As such, the backflow-preventing rib 218 acts as a wall or barrier that prevents the molten plastic from reaching the body of the pull-cup 104. In other words, the backflow-preventing rib 218 prevents molten resin from flowing back through the receiving opening in the interior panel and up through the pull-cup 104 mating gap with the vehicle interior panel, creating an undesirable aesthetic during joining (e.g., ultrasonic welding or heat staking) and afterward.

The fastening device 212 also includes a backflow reservoir 220 between the meltable body 214 and the pull-cup bottom surface 210. The backflow reservoir 220 may serve as an additional volume where excess molten or semi-molten material may be collected and prevented from leaking into the pull-cup 104.

In an example, the fastening device 212 further includes lateral ribs 222-1 and 222-2 rising from the lateral sides of the meltable body 214. The lateral ribs 222-1 and 222-2 may align the meltable body 214 and pull-cup 104 vertically, as indicated in FIGS. 4A and 4B. Additional details regarding the alignment of the meltable body 214 via the lateral ribs 222-1 and 222-2 are provided below in connection with FIGS. 4A and 4B. In an example, the backflow-preventing rib 218 extends between and is perpendicular to the lateral ribs 222-1 and 222-2.

In an example, the fastening device 212 includes chamfered corners 224-1 and 224-2 at the distal surface of the meltable body 214. In addition to the inverted alignment depression 216, the chamfered corners 224-1 and 224-2 further align the joining tool tip to the meltable body 214. Specifically, as depicted in FIG. 4B, the joining tool end may have an interior radius of curvature. The radius of curvature of the chamfered corners 224-1 and 224-2 of the distal end of the meltable body 214 may match the interior radius of curvature of the joining tool to ensure proper alignment of the joining tool, and thus, proper joining of the pull-cup 104 to the interior panel.

FIG. 3 illustrates one embodiment of the pull-cup 104 installed in an interior panel 326 of a vehicle door 100. Specifically, FIG. 3 depicts a view of a portion of the interior panel 326 that faces the exterior panel of the vehicle door 100 with the exterior panel of the vehicle door 100 removed. That is, as depicted in FIG. 3, the meltable bodies 214-1 and 214-2 are disposed in a space between the interior panel 326 of the vehicle door 100 and an exterior panel of the vehicle door 100, while the pull-cup 104 is outside of this gap, on the interior portion of the cabin of the vehicle. Note that FIG. 3 depicts the pull-cup 104 before the formation of buttons via heat staking or ultrasonic welding. FIG. 5 below depicts the buttons formed of the meltable body 214 that retain the pull-cup 104 against the interior panel 326.

FIGS. 4A and 4B depict cross-sectional views of the meltable body fastening device 212 and joining tool 428 for attaching the pull-cup 104 to the interior panel 326 of the vehicle door 100. Specifically, FIG. 4A is a cross-sectional view taken of the fastening device 212 taken along the line 4A-4A in FIG. 2 and FIG. 4B is a cross-sectional view taken along the line 4B-4B in FIG. 2.

As described above, the joining tool 428 (e.g., heat stake took or ultrasonic welding horn) generates heat and pushes against the meltable body 214 in a first direction 434, which in the perspective of FIG. 4A is a horizontal direction, to form a mating button/rivet on the opposite surface of the interior panel 326 from where the pull-cup 104 body resides. The end of the joining tool 428 includes a heating or vibrating tip 432. Whether manually or robotically operated, there may be some movement of the tip 432 in the first direction 434, a second direction 436, and/or a third direction 444 across the distal surface of the meltable body 214. If the tip 432 is misaligned in any of these directions, the button (see FIG. 5) may be asymmetrical, which could reduce part aesthetics and/or strength. As such, as described above, the locating alignment depression 216 ensures proper alignment of the tip 432 with the meltable body 214 in the first direction 434, second direction 436, and/or the third direction 444. That is, the inverted alignment depression acts as a centering guide for the joining tool 428. Thus, the inverted alignment depression 216 ensures repeatable and reliable plastic weld buttons/rivets. FIGS. 4A and 4B depict the inverted alignment depression 216 having a particular shape and size (i.e., a cone). However, the inverted alignment depression 216 may take a variety of shapes and sizes, with the size and shape of the inverted alignment depression 216 matching the size and shape of the joining tool tip 432. In an example, the meltable body 214 includes a protrusion extending from the top surface of the meltable body 214 to provide additional material for the formation of the inverted alignment depression 216.

FIG. 4A also depicts a second lateral rib 222-2, which aligns the pull-cup 104 in a second direction 436. As depicted, the second lateral rib 222-2 is angled and increases in height as the meltable body 214 is inserted through the receiving opening in the interior panel 326. That is, in an example, these lateral ribs 222 may have angled surfaces such that a clearance between the top surface of the lateral ribs 222 and the opening is smaller as the meltable body 214 is inserted further into the receiving opening. When the pull-cup 104 is fully seated, the lateral ribs 222 may provide a small clearance, for example between 0.1-0.2 millimeter (mm), between the meltable body 214 and the receiving opening to ensure the pull-cup 104 is properly seated within the interior panel 326. That is, the lateral ribs 222 may serve as a datum to align the pull-cup 104 within the interior panel 326 in the second direction 436.

FIG. 4A also depicts the backflow-preventing rib 218 and the backflow reservoir 220 that prevent molten or semi-molten plastic backflow from the meltable body 214 to the pull-cup bottom surface 210. Note that both of these components are angled with respect to a first direction 434, which may facilitate manufacturing. That is, the pull-cup 104 and its integrated components may be formed via die molding. These components have angled surfaces that align with a die angle 435 to facilitate the facile removal of the part from the mold after the molten material has been injected into the die and allowed to cool.

FIG. 4A also clearly depicts the meltable body's connection to the bottom surface 210 of the pull-cup 104. In an example, this connection includes an additional structural component. Specifically, the fastening device 212 may include an arm 442 extending from the pull-cup bottom surface 210. The arm 442, with its associated dimensions, prevents deformations to the pull-cup 104 that may arise from uneven cooling. For example, when the meltable body 214 is cooling following the heat staking or ultrasonic welding process, the meltable body 214 may be at a different temperature and/or cool at a different rate from the rest of the pull-cup 104 body. This may cause the pull-cup bottom surface 210 to suck in and form a depression. As such, the arm 442, having a smaller cross-sectional dimension than the pull-cup bottom surface 210, prevents this deformation. In an example, the thickness 440 of the arm 442 may be 50% or less of the thickness 438 of the pull-cup bottom surface 210. In an example, the thickness 440 of the arm 442 may be 40% or less of the thickness 438 of the pull-cup bottom surface 210. For example, the pull-cup bottom surface thickness 438 may be 2.5 mm. In this example, the arm 442, at the attachment point to the bottom surface 210, may have a thickness 440 of 1 mm.

As depicted, the arm 442 may be perpendicular to the bottom surface 210 of the pull-cup 104, and the meltable body 214 may extend perpendicularly from the arm 442 and parallel to the bottom surface 210 of the pull-cup 104. The arm 442 may partly define a concave backflow reservoir 220. As described above, the backflow reservoir 220 may serve as an additional basin that captures any excess molten or semi-molten plastic flow.

FIGS. 4A and 4B, specifically FIG. 4B, also depicts the chamfered corners 224-1 and 224-2 at the distal end of the meltable body 214 which further align the joining tool 428 with the meltable body 214. As depicted in FIGS. 4A and 4B, the joining tool 428 includes a torus 430 or ring-shape feature surrounding the tip 432. This torus, in part, defines the shape of the button that is formed from the softening of the meltable body 214. That is, as the tip 432 heats and presses against the meltable body 214, the molten material is shaped by the torus 430. In this example, the torus 430 has a particular interior radius of curvature. The chamfered, or rounded, corners 224-1 and 224-2 of the meltable body 214 may have a radius of curvature to match the interior radius of curvature of the joining tool 428, as depicted in FIG. 4B. Doing so may align the joining tool 428 to the meltable body 214 in a third direction 444, which third direction 444 may be perpendicular to the first direction 434 and the second direction 436.

That is, in addition to the inverted alignment depression 216, chamfers around the periphery of the meltable body 214 also serve to center the heating tool 428, using the interior radius of curvature of the joining tool 428. That is, the interior of the joining tool 428 may be concave, as depicted in FIG. 4B. The curves of the chamfers may align with the curvature of the joining tool 428 to ensure that the joining tool 428 is aligned with the surface of the meltable body 214 to be melted.

While FIGS. 4A and 4B depict the joining tool 428 and chamfered corners 224-1 and 224-2 as having particular dimensions and geometric characteristics, the chamfered corners 224-1 and 224-2 may have other dimensions and geometric characteristics to match the dimensions and geometric characteristics of the joining tool 428.

FIG. 5 depicts buttons 546-1 and 546-2 formed by melting the meltable body 214 to attach the pull-cup 104 to the interior panel 326 of the vehicle door 100. As described above, responsive to treatment from a joining tool 428 and cooling, the meltable body 214 forms a button 546-1 and 546-2 on an opposite surface of the interior panel 326 from where the pull-cup 104 is located. The buttons 546-1 and 546-2 affix the pull-cup 104 to the interior panel 326. The underlying surfaces of the buttons 546-1 and 546-2 engage with the surface of the interior panel 326 that surrounds the receiving hole, which tightly secures the pull-cup 104 to the interior panel 326. While FIG. 5 depicts donut or torus-shaped buttons 546-1 and 546-2, the buttons 546-1 and 546-2 may take a variety of shapes and sizes based on the form of the joining tool 428. Examples of other button 546-1 and 546-2 shapes include a hemisphere, a rectangle, or a square.

FIG. 6 illustrates one embodiment of a thermoplastic body 650 that incorporates the meltable body fastening device 212 disclosed herein. As described above, while particular reference is made to a pull-cup 104 thermoplastic body, the injection-molded thermoplastic device 648 may take a variety of shapes, an additional example of which is depicted in FIG. 6. As described above, the injection-molded thermoplastic device 648 includes a thermoplastic body 650 attachable to a substrate surface 652. In the example depicted in FIG. 6, the thermoplastic body 650 is the first vehicle door panel, and the substrate surface 652 is a second vehicle door panel.

The injection-molded thermoplastic body 648 includes the fastening device 212 attached to the thermoplastic body 650 to affix the thermoplastic body 650 to the substrate surface 652. For simplicity, one fastening device 212 is identified with a reference number. The fastening device 212 includes the meltable body 214 affixed to the surface of the thermoplastic body 650 and extending away from the thermoplastic body 650. FIG. 6 also depicts the inverted alignment depression 216 on a distal surface of the meltable body 214 and the backflow-preventing rib 218 extending between lateral sides of the meltable body 214. FIG. 6 also depicts the backflow reservoir 220 between the meltable body 214 and the surface. As described above, the meltable body 214 includes lateral ribs 222-1 and 222-2 formed on the lateral sides of the meltable body 214 and chamfered corners 224-1 and 224-2 that have a radius of curvature to match an interior radius of curvature of a joining tool 428. While particular reference is made to particular forms of the thermoplastic body 650, the injection-molded thermoplastic device 648 may take various forms, such as any multi-component part to be assembled. This could be a system where one part is dynamically loaded and exhibits stress on the other and/or a system where two adjoining parts are more rigidly attached yet are static in nature. Other examples include a vehicle door 100 map pocket or bottle holder.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An injection-molded thermoplastic device, comprising:
a thermoplastic body attachable to a substrate surface; and
a fastening device attached to the thermoplastic body to affix the thermoplastic body to the substrate surface, the fastening device comprising:
a meltable body affixed to a bottom surface of the thermoplastic body and extending away from the thermoplastic body;
an inverted alignment depression on a distal surface of the meltable body; and
a backflow-preventing rib extending between lateral sides of the meltable body.

2. The injection-molded thermoplastic device of claim 1, wherein:
the thermoplastic body is a pull-cup; and
the substrate surface is an interior panel of a vehicle door.

3. The injection-molded thermoplastic device of claim 2, wherein the meltable body extends away from the pull-cup in a direction that is opposite to a direction of a pull surface of the pull-cup.

4. The injection-molded thermoplastic device of claim 1, further comprising a backflow reservoir between the meltable body and the bottom surface.

5. The injection-molded thermoplastic device of claim 1, wherein, responsive to treatment from a joining tool and cooling, the meltable body forms a button on an opposite surface of the substrate surface from where the thermoplastic body is located to affix the thermoplastic body to the substrate surface.

6. The injection-molded thermoplastic device of claim 1, wherein:
the fastening device further comprises an arm extending from the bottom surface; and
the meltable body is attached to the arm.

7. The injection-molded thermoplastic device of claim 6, wherein an arm thickness is less than 50% of a bottom surface thickness.

8. The injection-molded thermoplastic device of claim 1, further comprising lateral ribs formed on the lateral sides of the meltable body.

9. The injection-molded thermoplastic device of claim 1, further comprising chamfered corners at the distal surface of the meltable body, the chamfered corners having a radius of curvature to match an interior radius of curvature of a joining tool.

10. The injection-molded thermoplastic device of claim 1, wherein the fastening device is integrated with the thermoplastic body.

11. The injection-molded thermoplastic device of claim 1, wherein the inverted alignment depression has a shape to match a joining tool tip shape.

12. The injection-molded thermoplastic device of claim 1, wherein the meltable body has a rectangular cross-section to match a receiving hole in the interior panel.
